(19) United States
(12) Patent Application Publication
(10) Pub. No.: US 2018/0043840 A1
(43) Pub. Date: Feb. 15, 2018

(54) PORTABLE DEVICE HOLDER

(71) Applicant: Kenu, Inc., San Francisco, CA (US)

(72) Inventors: Kenneth Y. Minn, San Francisco, CA (US); David E. Yao, San Francisco, CA (US); Gregory D. Caneer, Oakland, CA (US); Leonard John Duran, Mill Valley, CA (US)

(73) Assignee: Kenu, Inc., San Francisco, CA (US)

(21) Appl. No.: 15/722,286

(22) Filed: Oct. 2, 2017

Related U.S. Application Data
(63) Continuation-in-part of application No. 15/653,897, filed on Jul. 19, 2017.
Application No. 15/653,897 is a continuation of application No. 14/736,090, filed on Jun. 10, 2015, now Pat. No. 9,718,412.
Application No. 14/736,090 is a continuation of application No. 13/897,062, filed on May 17, 2013, now Pat. No. 9,080,714.
Application No. 13/897,062 is a continuation-in-part of application No. 29/437,793, filed on Nov. 20, 2012, now Pat. No. D690707.
Application No. 29/437,793 is a continuation-in-part of application No. 29/607,125, filed on Jun. 9, 2017.
Application No. 29/607,125 is a continuation-in-part of application No. 29/607,126, filed on Jun. 9, 2017.

(51) Int. Cl. B60R 11/02; F16M 13/02; F16M 11/10; F16M 13/00; F16B 2/06; F16M 11/04

(52) U.S. Cl. CPC B60R 11/02; B60R 11/0241; F16B 2/065; F16M 11/041; F16M 11/105; F16M 13/00; F16M 13/022; B60R 11/0258; B60R 2011/0008

(57) ABSTRACT

A portable device holder includes a device attachment element and a mounting element rotatably attached to one another. The device attachment element includes a main body and is configured to be selectively attached to a portable device. The mounting element is configured to attach the portable device holder to a mounting surface. The mounting element includes mounting arms including a mounting slot defined therebetween. The mounting element is rotatable and pivotable relative to the device attachment element and thereby enables the mounting slot to be selectively pivoted and selectively rotated between vertical and horizontal arrangements relative to the device attachment element.p

### PRIORITY CLAIM

This present application is a continuation-in-part (CIP) of U.S. patent application Ser. No. 15/653,897, filed Jul. 19, 2017 and titled ADJUSTABLE PORTABLE DEVICE HOLDER, which is a continuation of U.S. patent application Ser. No. 14/736,090, filed Jun. 10, 2015 and titled ADJUSTABLE PORTABLE DEVICE HOLDER (issued as U.S. Pat. No. 9,718,412), which is a continuation of U.S. patent application Ser. No. 13/897,062, filed May 17, 2013 and titled ADJUSTABLE PORTABLE DEVICE HOLDER (issued as U.S. Pat. No. 9,080,714), which is a continuation-in-part (CIP) of U.S. Design Pat. application No. 29/437,793, filed Nov. 20, 2012 and titled DASHBOARD VENT MOUNT FOR AN ELECTRONIC DEVICE (issued as U.S. Pat. No. Des. 690,707). The present application is also a continuation-in-part (CIP) of U.S. Design Pat. application No. 29/607,125, filed Jun. 9, 2017 and titled DASHBOARD VENT MOUNT FOR AN ELECTRONIC DEVICE. The present application is also a continuation-in-part (CIP) of U.S. Design Pat. application No. 29/607,126, filed Jun. 9, 2017 and titled DASHBOARD VENT MOUNT FOR AN ELECTRONIC DEVICE. Priority is claimed to each of the above listed applications, each of which is incorporated herein by reference.

### FIELD OF TECHNOLOGY

The present application is directed to adjustable portable device holder systems and methods.

### BACKGROUND

Various electronic and other device mounts are known in the art. Available device mounts have many drawbacks. For instance, suction cup mounts are typically large, bulky and require a large mounting surface such as a windshield. Device mounts often fail to properly and consistently attach to the mounting surface. Some device mounting solutions require adhesive to secure the mount to a vehicle dash, wearing off over time and leaving an undesirable residue on the mounting surface. Current device mounts also fail to effectively accommodate a broad range of devices or mounting surfaces.

Due to the deficiencies in the currently available device mounts, people choose not use electronic device mounts and often violate state and provincial hands-free driving laws. Other state and provincial laws prohibit objects mounted to the windshield to prevent obstruction of the driver's view.

This specification is directed to improved portable device holder systems and methods for manufacturing the same.

### SUMMARY

Adjustable portable device holder systems and methods for manufacturing the same are herein disclosed. According to one embodiment, an adjustable portable device holder includes an adjustable clamping element and a rotatable mounting element attached to the adjustable clamping element for removably securing a portable device to the adjustable portable device holder. The adjustable clamping element is capable of being biased into an activated state and unbiased into a deactivated state to secure one of a plurality of different size portable devices to the adjustable portable device holder. The rotatable mounting element, attached to the adjustable clamping element, includes a plurality of mounting arms each spaced a specified distance apart from one another and extending at a specified angle from a bottom surface of the rotatable mounting element. Each pair of the plurality of mounting arms forms a mounting slot therein between. The rotatable mounting element is capable of being rotated to position a first mounting slot in a vertical, horizontal or diagonal orientation and a second mounting slot in a vertical, horizontal or diagonal orientation to engage a first mounting surface in a vertical, horizontal or diagonal orientation or a second mounting surface in a vertical, horizontal or diagonal orientation.

In another embodiment, a process for manufacturing an exemplary adjustable portable device holder is disclosed. The process includes providing an adjustable clamping element capable of being biased into an activated state and unbiased into a deactivated state to secure one of a plurality of portable device sizes to the adjustable portable device holder. The process also includes providing a rotatable mounting element comprising a plurality of mounting arms each spaced a specified distance apart from one another and extending at a specified angle from a bottom surface of the rotatable mounting element. Each pair of the plurality of mounting arms form a mounting slot therein between. The rotatable mounting element is capable of being rotated to position a first mounting slot in a vertical, horizontal or diagonal orientation and a second mounting slot in a vertical, horizontal or diagonal orientation to engage a first mounting surface in a vertical, horizontal or diagonal orientation or a second mounting surface in a vertical, horizontal or diagonal orientation. The process also includes attaching the rotatable mounting element to the adjustable clamping element.

In accordance with certain embodiments, a portable device holder includes a device attachment element and a mounting element. The device attachment element is configured to be selectively attached to a portable device. The mounting element is rotatably and pivotable attached to a main body of the device attachment element. The mounting element includes first and second mounting arms extending in a direction away from the main body of the device attachment element and defining a mounting slot behind the main body of the device attachment element. The mounting slot is configured to accommodate engagement with an air conditioner vent of an automobile or some other mounting surface. The mounting slot is rotatable and pivotable relative to the device attachment element by rotating and pivoting the mounting element relative to the main body of the device attachment element thereby enabling the mounting slot behind the main body of the device attachment element to be selectively pivoted and selectively rotated between vertical and horizontal arrangements relative to the device attachment element. The device attachment element can include an adjustable clamping element. The device attachment element can alternatively include one or more magnets within its main body. In certain embodiments, the device attachment element and the mounting element are attached to one another by a ball and socket joint.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The foregoing and other objects, features and advantages of the present disclosure will become more readily apparent from the following detailed description of exemplary embodiments as disclosed herein.

### BRIEF DESCRIPTION OF THE DRAWINGS

Embodiments of the present application are described, by way of example only, with reference to the attached Figures, wherein:

FIG. 1 illustrates an adjustable portable device holder in a retracted setting, also referred to as the deactivated state, according to one embodiment;

FIG. 2 illustrates an adjustable portable device holder in an expanded setting, also referred to as the activated state, according to one embodiment;

FIG. 3 illustrates an adjustable portable device holder in a retracted setting according to one embodiment;

FIGS. 4A and 4B illustrate an adjustable portable device holder attached to a device and a mounting surface according to one embodiment;

FIG. 5 illustrates a flow chart of a process for manufacturing an exemplary adjustable portable device holder according to one embodiment;

FIG. 6 is an elevation view of the back of an adjustable portable device holder in a retracted setting;

FIG. 7 is a plan view of the top of an adjustable portable device holder in a retracted setting;

FIG. 8 is an elevation view of left side of an adjustable portable device holder in a retracted setting;

FIG. 9 is an elevation view of the front of an adjustable portable device holder in a retracted setting;

FIG. 10 is an elevation view of the right side of an adjustable portable device holder in a retracted setting;

FIG. 11 is a plan view of the bottom of an adjustable portable device holder in a retracted setting;

FIG. 12 is an isometric view, from the front right, of an adjustable portable device holder in a retracted setting;

FIG. 13 is an isometric view, from the back left, of an adjustable portable device holder FIG. 14 is an elevation view of the back of an adjustable portable device holder in an expanded setting;

FIG. 15 is a plan view of the top of an adjustable portable device holder in an expanded setting;

FIG. 16 is an elevation view of left side of an adjustable portable device holder in an expanded setting;

FIG. 17 is an elevation view of the front of an adjustable portable device holder in an expanded setting;

FIG. 18 is an elevation view of the right side of an adjustable portable device holder in an expanded setting;

FIG. 19 is a plan view of the bottom of an adjustable portable device holder in an expanded setting;

FIG. 20 is an isometric view, from the front right, of an adjustable portable device holder in an expanded setting;

FIG. 21 is an isometric view, from the back left, of an adjustable portable device holder in an expanded setting;

FIG. 22 is a rear perspective view of an adjustable portable device holder according to a second embodiment of the present invention with its adjustable clamping element in a retracted setting, also referred to as the deactivated state, and its mounting element, also referred to in the second embodiment as its vent attachment jaws, in a closed position;

FIG. 23 is a rear perspective view of the adjustable portable device holder according to the second embodiment of the present invention with its adjustable clamping element in an expanded setting, also referred to as the activated state, and its mounting element, also referred to in the second embodiment as its vent attachment jaws, in a closed position;

FIG. 24 is a rear perspective view of the adjustable portable device holder according to the second embodiment of the present invention with its adjustable clamping element in the retracted setting, also referred to as the deactivated state, and its mounting element, also referred to in the second embodiment as its vent attachment jaws, in an open position;

FIG. 25 is a right elevation view of the adjustable portable device holder according to the second embodiment of the present invention with its mounting element, also referred to in the second embodiment as its vent attachment jaws, in a closed position, also referred to as its deactivated position;

FIG. 26 is a right elevation view of the adjustable portable device holder according to the second embodiment of the present invention with its mounting element, also referred to in the second embodiment as its vent attachment jaws, in an open position, also referred to as its activated position;

FIGS. 27 and 28 are respectively rear perspective and right elevation views of the adjustable portable device holder according to the second embodiment of the present invention with the adjustable clamping element and the mounting element shown separate from one another;

FIG. 29 is a rear elevation view of the mounting element portion of the adjustable portable device holder according to the second embodiment of the present invention, wherein the mounting element, also referred to in the second embodiment as its vent attachment jaws, is in a closed position, also referred to as its deactivated position;

FIG. 30A is a cross-sectional side view of the mounting element portion of the adjustable portable device holder according to the second embodiment of the present invention along the line A-A shown in FIG. 29, wherein the mounting element, also referred to in the second embodiment as its vent attachment jaws, is in a closed position, also referred to as its deactivated position;

FIG. 30B is a cross-sectional side view of the mounting element portion of the adjustable portable device holder according to the second embodiment of the present invention along the line B-B shown in FIG. 29, wherein the mounting element, also referred to in the second embodiment as its vent attachment jaws, is in a closed position, also referred to as its deactivated position;

FIG. 31 is a rear elevation view of the mounting element portion of the adjustable portable device holder according to the second embodiment of the present invention, wherein the mounting element, also referred to in the second embodiment as its vent attachment jaws, is in a open position, also referred to as its activated position;

FIG. 32A is a cross-sectional side view of the mounting element portion of the adjustable portable device holder according to the second embodiment of the present invention along the line A-A shown in FIG. 31, wherein the mounting element, also referred to in the second embodiment as its vent attachment jaws, is in a open position, also referred to as its activated position;

FIG. 32B is a cross-sectional side view of the mounting element portion of the adjustable portable device holder according to the second embodiment of the present invention along the line B-B shown in FIG. 31, wherein the mounting element, also referred to in the second embodiment as its vent attachment jaws, is in a open position, also referred to as its activated position;

FIG. 33 is an exploded rear perspective view of the mounting element portion of the adjustable portable device holder according to the second embodiment of the present invention;

FIG. 34 is a front perspective view of an adjustable portable device holder according to a third embodiment of the present invention;

FIGS. 35 and 36 are respectively rear perspective and right elevation views of the adjustable portable device holder according to the third embodiment of the present invention with the device attachment element and the mounting element shown separate from one another; and

FIG. 37 is an exploded front perspective view of the device attachment element of the adjustable portable device holder according to the third embodiment of the present invention.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein.

The adjustable portable device holders described in this specification can include an adjustable clamping element or other type of device attachment element attached to a rotatable mounting element. The adjustable portable device holder can be used to attach and mount a portable device to a mounting surface. The portable device can be any device that attaches to the device attachment element (e.g., fits into the adjustable clamping element) including, but not limited to a smartphone or other phone, a tablet, an e-reader, a powerbank, a speaker, a multimedia player, a flashlight or other light, a television or other display, a laser or radar detector, an air freshener, a fan, a beverage or other device that can fit into the adjustable clamping element. The adjustable portable device holder can be mounted to various mounting surfaces including, but not limited to an automobile air conditioner vent blade, an automobile dashboard, an automobile sun visor, a credit card, the brim of a hat, a counter, a tripod, a bicycle, a backpack, a utensil, a ledge or other surface.

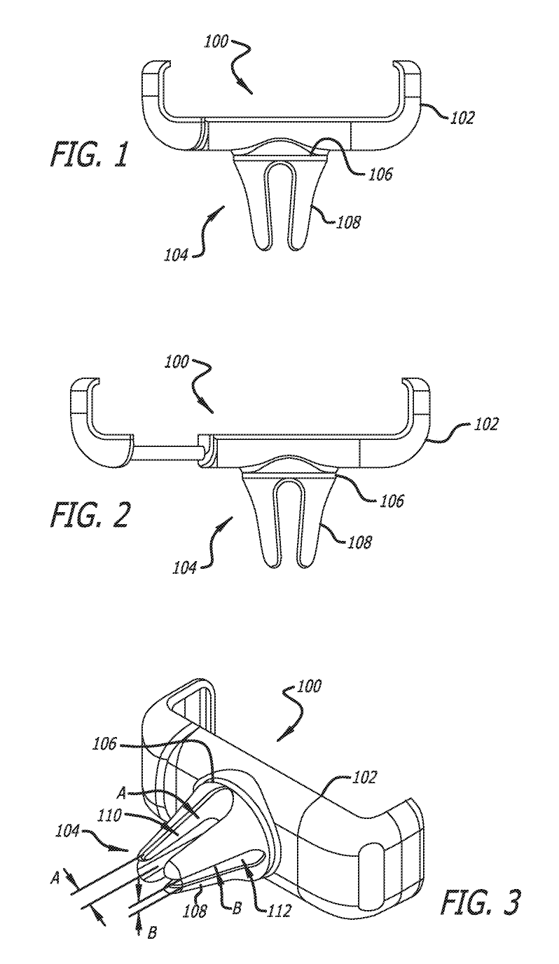

FIG. 1 illustrates an adjustable portable device holder 100 in a retracted setting according to one embodiment. The adjustable portable device holder 100 includes an adjustable clamping element 102 attached to a rotatable mounting element 104.

FIG. 2 illustrates an adjustable portable device holder 100 in an expanded setting according to one embodiment. The adjustable portable device holder 100 includes an adjustable clamping element 102 attached to a rotatable mounting element 104.

FIG. 3 illustrates an adjustable portable device holder 100 in a retracted setting according to one embodiment. The adjustable portable device holder 100 includes an adjustable clamping element 102 attached to a rotatable mounting element 104.

The adjustable clamping element 102 illustrated in FIGS. 1-3 can be expanded and retracted to attach devices of different sizes to the adjustable portable device holder 100. A force can be applied to expand or bias the adjustable clamping element 102 into an activated state (shown in FIG. 2) and the force can be released to retract the adjustable clamping element 102 into a deactivated state (shown in FIGS. 1 and 3). An elastic retracting or biasing element (not shown), such as a compression or torsion spring can be incorporated into the adjustable clamping element 102. The compression or torsion spring facilitates the expansion and retraction of the adjustable clamping element 102 upon applying or releasing an expansive force on a surface of the adjustable clamping element 102.

The adjustable clamping element 102 can also include a gripping material on a surface of the adjustable clamping element 102 to provide a better grip, a better viewing angle or better attachment to a device secured within the adjustable clamping element 102. The gripping material can be applied to a portion of the adjustable clamping element 102 or the entire adjustable clamping element 102 can be made of the gripping material. The gripping material can be any material that increases the adhesion, grip or coefficient of friction between the gripping surface of the adjustable clamping element 102 and a surface of a device secured within the adjustable clamping element 102. The gripping material can include, but is not limited to rubber, polymeric material or other plastic, metal, alloy, fabric, composite material or other material capable of increasing the adhesion, grip or coefficient of friction between the gripping surface of the adjustable clamping element 102 and a surface of a device secured within the adjustable clamping element 102. The gripping material and gripping surface can be textured and composed of the same or different material.

The rotatable mounting element 104 illustrated in FIGS. 1-3 can be directly or indirectly attached to the adjustable clamping element 102. The adjustable clamping element 102 and the rotatable mounting element 104 can be one integral part or component parts that are attached together by any attaching means that allows the rotatable mounting element 104 to rotate. The rotatable mounting element 104 includes a base plate 106 and a plurality of mounting arms 108 extending from the base plate 106. The base plate 106 and the plurality of mounting arms 108 can be one integral part or component parts that are attached together by any attaching means.

Referring to FIG. 3, the base plate 106 can be a cylindrically shaped disc or other element that is capable of being rotated 360 degrees clockwise or counter-clockwise. The base plate 106 provides a rotating platform from which mounting arms 108 extend. The mounting arms 108 are spaced a specified distance apart relative to one another on the base plate 106. The mounting arms 108 also extend from the base plate 106 at a specified angle relative to the base plate 106. The size of the mounting arms 108, the distance between the mounting arms 108 and the angle at which the mounting arms 108 extend from the base plate 106 establish and define mounting slots 110, 112 between pairs of mounting arms 108. The rotatable mounting element 104 can include any number of mounting arms 108 and any number of mounting slots 110, 112.

The mounting arms 108 can also include a gripping material on a surface of the mounting arms 108 to provide a better grip, a better viewing angle or better attachment to a mounting surface secured between the mounting arms 108. The gripping material can be applied to a portion of mounting arms 108 or the entirety of the mounting arms 108 can be made of the gripping material. The gripping material can be any material that increases the adhesion, grip or coefficient of friction between the gripping surface of mounting arms 108 and a mounting surface secured between the mounting arms 108. The gripping material can include, but is not limited to rubber, polymeric material or other plastic, metal, alloy, fabric, composite material or other material capable of increasing the adhesion, grip or coefficient of friction between the gripping surface of mounting arms 108 and a mounting surface secured between the mounting arms 108. The gripping material and gripping surface can be textured and composed of the same or different material.

In one exemplary embodiment, the rotatable mounting element 104 includes four mounting arms and four mounting slots. In another exemplary embodiment, the rotating mounting element 104 includes 6 mounting arms and six mounting slots.

The mounting arms 108 and mounting slots 110, 112, can engage a mounting surface (not shown) to mount the adjustable portable device holder 100. The adjustable portable device holder 100 is mounted to a mounting surface by positioning, press fitting or wedging a mounting surface within one or more mounting slots 110, 112 to engage two or more mounting arms 108. The adjustable portable device holder 100 can be mounted to various mounting surfaces including, but not limited to an automobile air conditioner vent blade, an automobile dashboard, an automobile sun visor, a credit card, the brim of a hat, a counter, a tripod, a bicycle, a backpack, a utensil, a ledge or other surface that can be positioned, press fit or wedged within one or more mounting slots 110, 112 between two or more mounting arms 108.

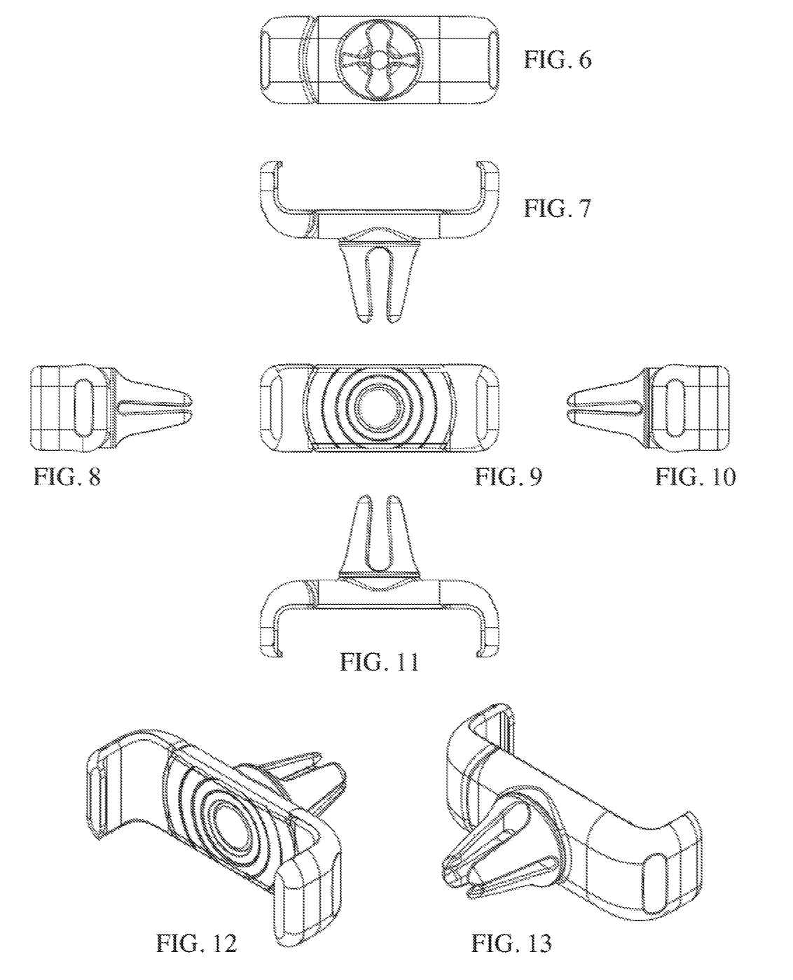

The rotatable mounting element 104 can include any number of mounting arms 108 forming and defining any number of mounting slots 110, 112. As may be appreciated in at least FIGS. 1-3, 7, 8, 10, 11. 15, 16, 18 and 19, the size and shape of the mounting slots 110, 112 formed between pairs of mounting arms 108 can be controlled by adjusting the size and shape of the paired mounting arms 108, the distance between the mounting arms 108 and the angle at which the two mounting arms 108 extend from the base plate 106 and converge toward one another. As depicted, each mounting arm 108 and mounting slot 110, 112 tapers in a direction away from a bottom surface of the rotatable mounting element 104. The rotatable mounting element 104 can include one or more different size mounting slots 110, 112 to accommodate different size mounting surfaces. For instance in FIG. 3, one mounting slot 110 having clearance A can be larger than another mounting slot 112 having clearance B. One or more of the mounting slots 110 formed on the rotatable mounting element 104 can accommodate a larger mounting surface than other mounting slots 112 formed on the rotatable mounting element 104.

The rotatable mounting element 104 can be rotated to position the mounting arms 108 and mounting slots 110, 112 in a horizontal plane, vertical plane, diagonal plane, circular plane, concave plane, convex plane or any plane between vertical and horizontal planes relative to the force of gravity. The mounting arms 108 and mounting slots 110, 112 can be positioned to engage a mounting surface in any engagement plane within the 360 degree rotation of the mounting element 104. The rotatable mounting element 104 can be rotated to position a relatively larger mounting slot 110 with clearance A in a horizontal, vertical, diagonal, circular, concave or convex plane to engage a relatively larger mounting surface in a horizontal, vertical, diagonal, circular, concave or convex engagement plane. The rotatable mounting element 104 can also be rotated to position a relatively smaller mounting slot 112 with clearance B in a horizontal, vertical, diagonal, circular, concave or convex plane to engage a relatively smaller mounting surface in a horizontal, vertical, diagonal, circular, concave or convex engagement plane.

The rotatable mounting element is capable of being rotated 360 degrees clockwise or counter-clockwise to engage different size mounting surfaces in a horizontal plane, vertical plane, diagonal plane, circular plane, concave plane, convex plane or any plane between vertical and horizontal planes. A device attached to the adjustable portable device holder 100 via the adjustable clamping element 102 can also be rotated 360 degrees clockwise or counter-clockwise while it is attached to the adjustable portable device holder 100 by rotating the rotatable mounting element 104.

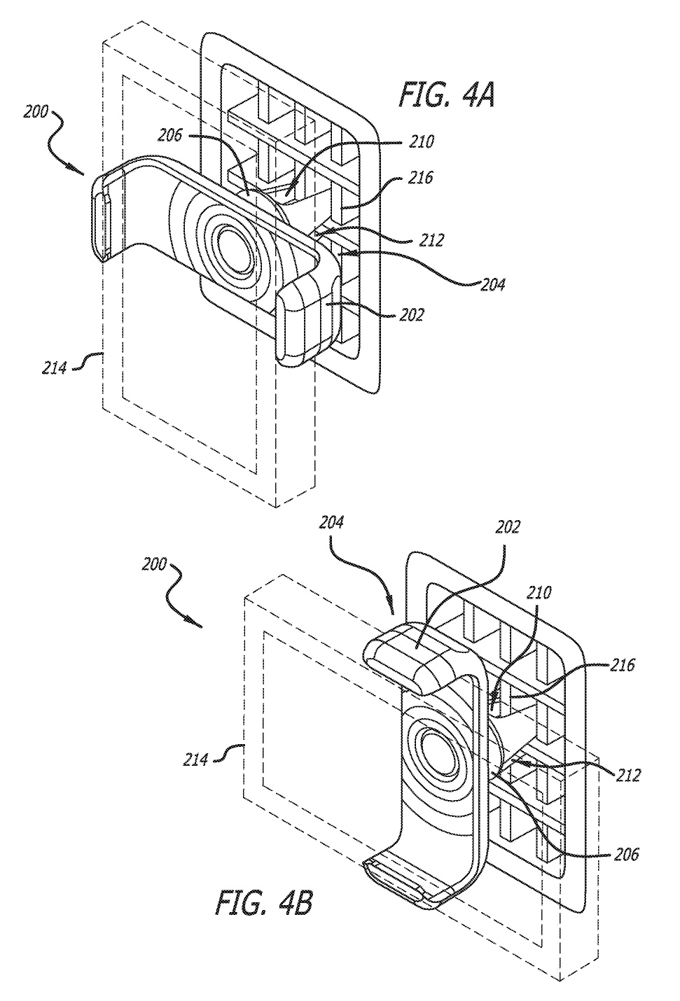

FIGS. 4A and 4B illustrate an adjustable portable device holder 200 attached to a device 214 and a mounting surface 216 according to one embodiment. The device 214 is a smart phone and the mounting surface 216 is an automobile air conditioner vent blade.

Other portable devices can also fit into the adjustable clamping element including, but not limited to a tablet, an e-reader, a powerbank, a speaker, a multimedia player, a flashlight or other light, a television or other display, a laser or radar detector, an air freshener, a fan, a beverage or other device. The adjustable portable device holder 200 can also be mounted to other mounting surfaces including, but not limited to an automobile dashboard, an automobile sun visor, a credit card, the brim of a hat, a counter, a tripod, a bicycle, a backpack, a utensil, a ledge or other surface.

The adjustable portable device holder 200 includes an adjustable clamping element 202 attached to a rotatable mounting element 204. The adjustable clamping element 202 can be expanded and retracted to attach different size smartphones to the adjustable portable device holder 200. A force can be applied to expand or bias the adjustable clamping element 202 into an activated state and the force can be released to retract the adjustable clamping element 202 into a deactivated state to clamp around the smartphone 214. An elastic retracting or biasing element (not shown), such as a compression or torsion spring can be incorporated into the adjustable clamping element 202 to facilitate the expansion and retraction of the adjustable clamping element 202 and to accommodate different size smartphones.

The adjustable clamping element 202 can also include a gripping material on a surface of the adjustable clamping element 202 to provide a better grip, a better viewing angle or better attachment to the smart phone 214 or other device secured within the adjustable clamping element 202. The gripping material can be applied to a portion of the adjustable clamping element 202 or the entire adjustable clamping element 202 can be made of the gripping material. The gripping material can be any material that increases the adhesion, grip or coefficient of friction between the gripping surface of the adjustable clamping element 202 and a surface of a device secured within the adjustable clamping element 202. The gripping material can include, but is not limited to rubber, polymeric material or other plastic, metal, alloy, fabric, composite material or other material capable of increasing the adhesion, grip or coefficient of friction between the gripping surface of the adjustable clamping element 202 and a surface of a device secured within the adjustable clamping element 202. The gripping material and gripping surface can be textured and composed of the same or different material.

The rotatable mounting element 204 can be directly or indirectly attached to the adjustable clamping element 202. The adjustable clamping element 202 and the rotatable mounting element 204 can be one integral part or component parts that are attached together by any attaching means, such as a screw, ratchet, pin, rod or friction or other device that allows the rotatable mounting element 204 to rotate. The rotatable mounting element 204 includes a base plate 206 and a plurality of mounting arms 208 extending from the base plate 206. The base plate 206 and the plurality of mounting arms 208 can be one integral part or component parts that are attached together by any attaching means.

The base plate 206 can be a cylindrically shaped disc or other element that is capable of being rotated 360 degrees clockwise or counter-clockwise. The base plate 206 provides a rotating platform from which the mounting arms 208 extend. The mounting arms 208 are spaced a specified distance apart relative to one another on the base plate 206. The mounting arms 208 also extend from the base plate 206 at a specified angle relative to the base plate 206. The size of the mounting arms 208, the distance between the mounting arms 208 and the angle at which the mounting arms 208 extend from the base plate 206 establish and define mounting slots 210, 212 between pairs of mounting arms 208. The rotatable mounting element 204 includes four mounting arms 208 and four mounting slots 210, 212.

The mounting arms 208 and mounting slots 210, 212, can engage and attach to an air conditioner vent blade 216 to mount the adjustable portable device holder 200. The adjustable portable device holder 200 is mounted to the air conditioner vent blade 216 by positioning, press fitting or wedging a surface of the air conditioner vent blade 216 within one or more mounting slots 210, 212 to engage two or more mounting arms 208.

The mounting arms 208 can also include a gripping material on a surface of the mounting arms 208 to provide a better grip, a better viewing angle or better attachment to the air conditioner vent blade 216 secured between mounting arms 208. The gripping material can be applied to a portion of mounting arms 208 or the entirety of the mounting arms 208 can be made of the gripping material. The gripping material can be any material that increases the adhesion, grip or coefficient of friction between the gripping surface of mounting arms 208 and an air conditioner vent blade 216 secured between the mounting arms 208. The gripping material can include, but is not limited to rubber, polymeric material or other plastic, metal, alloy, fabric, composite material or other material capable of increasing the adhesion, grip or coefficient of friction between the gripping surface of mounting arms 208 and the air conditioner vent blade 216 secured between the mounting arms 208. The gripping material can be and gripping surface and composed of the same or different material.

The rotatable mounting element 204 includes two different sizes of mounting slots 210, 212 to accommodate different size air conditioner vent blades 216 or other mounting surfaces. Two mounting slots 210 having clearance A are larger than the other two mounting slots 212 having clearance B.

The rotatable mounting element 204 can be rotated to position the mounting arms 208 and mounting slots 210, 212 in a horizontal, vertical, diagonal, circular, concave, convex or any plane between vertical and horizontal planes to engage air conditioner vent blades 216 oriented in a horizontal, vertical, diagonal, circular, concave, convex or any plane between vertical and horizontal planes. The mounting arms 208 and mounting slots 210, 212 can be positioned to attach to an air conditioner vent blade in any engagement plane within the 360 degree rotation of the mounting element 204. The rotatable mounting element 204 can be rotated to position the larger mounting slots 210 with clearance A in a horizontal, vertical, diagonal, circular, concave, convex or any plane between vertical and horizontal planes to engage or attach to larger air conditioner vent blades 216 oriented in a horizontal, vertical, diagonal, circular, concave, convex or any plane between vertical and horizontal planes. The rotatable mounting element 204 can also be rotated to position the smaller mounting slots 212 with clearance B in a horizontal, vertical, diagonal, circular, concave, convex or any plane between vertical and horizontal planes to engage or attach to smaller air conditioner vent blades 216 oriented in a horizontal, vertical, diagonal, circular, concave, convex or any plane between vertical and horizontal planes.

The rotatable mounting element 204 is capable of being rotated 360 degrees clockwise or counter-clockwise to engage different size mounting surfaces in a horizontal, vertical, diagonal, circular, concave, convex or any plane between vertical and horizontal planes relative to the force of gravity. The smart phone 214 attached to the adjustable portable device holder 200 can be rotated into a portrait orientation (shown in FIG. 4A) and a landscape orientation (shown in FIG. 4B) by rotating the rotatable mounting element 204. The smart phone 214 attached to the adjustable portable device holder 200 can be rotated 360 degrees clockwise or counter-clockwise while it is attached to the adjustable portable device holder 200 by rotating the smart phone 214 and adjustable clamping element 202, while the rotatable mounting element 204 is secured to a mounting surface.

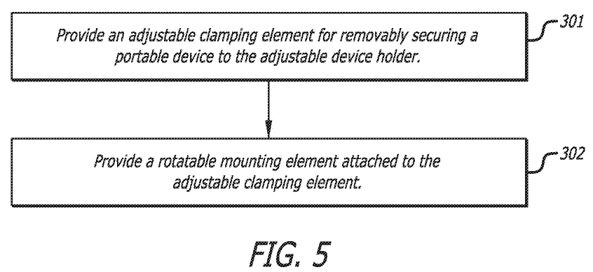

FIG. 5 illustrates a flow chart of a process for manufacturing an exemplary adjustable portable device holder according to one embodiment. At step 301, the process includes providing an adjustable clamping element for removably securing a portable device to the adjustable portable device holder. The adjustable clamping element is capable of being biased into an activated state and unbiased into a deactivated state to secure one of a plurality of different size portable device to the adjustable portable device holder.

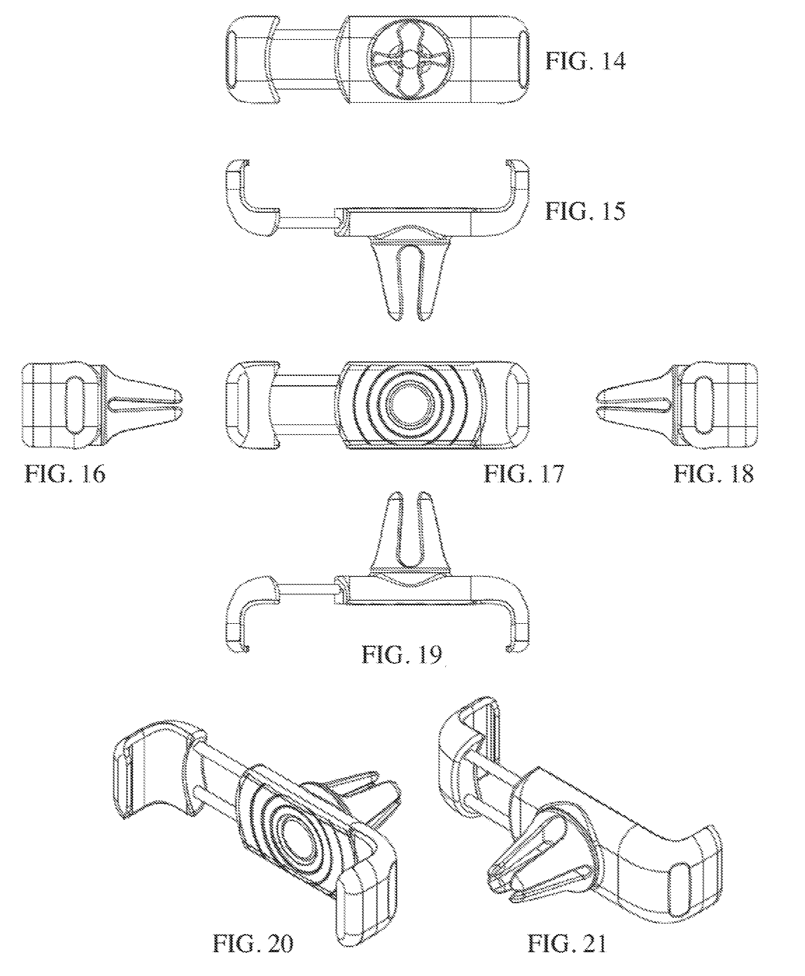

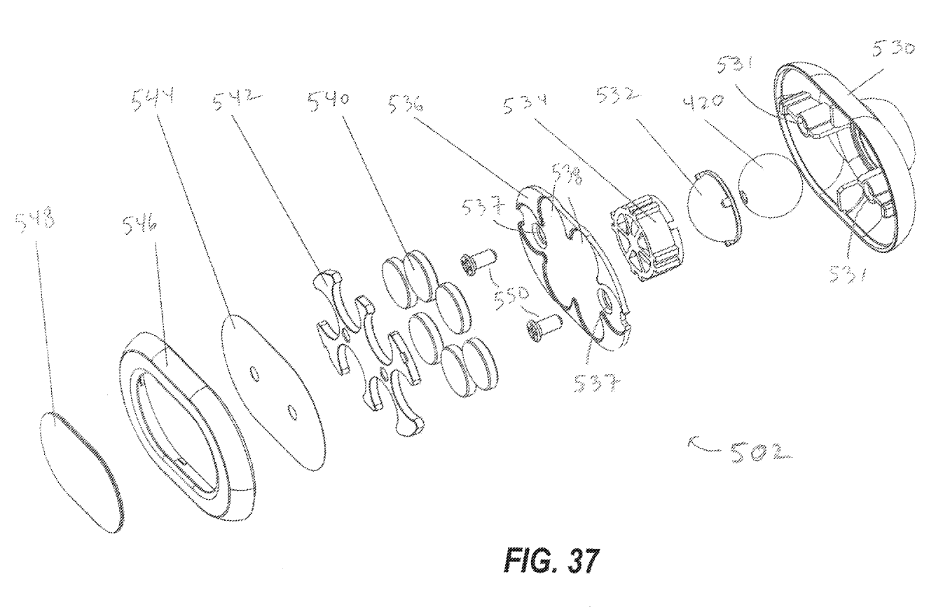

As an example and as depicted in FIGS. 2, 14, 15, 16 and 19-21, to manufacture the adjustable portable device holder, two stainless steel rods can be inserted into an expandable arm cavity of a double injection mold. PC/ABS is injected into the cavities of the mold to hold the rods in place and to produce an expandable arm, main body and cover of an adjustable clamping element. The mold is then rotated and injected with TPE (thermoplastic elastomers) to form side grips of the expandable arm and body of the adjustable clamping element. A stainless steel spring is inserted over each rod and held in place by a stainless steel screw affixed to the end of the rods. Grease is added to the lower portion of the spring and rods (near the screw head). The expandable arm is inserted into the body and the springs are lowered and held in place within the body of the adjustable clamping element. The cover is then slid on to the body to hold the adjustable arm in place.

The adjustable clamping element or a surface thereof can also be formed from rubber, polymeric material or other plastic, metal, alloy, or composite material that is rigid, semi-rigid or textured.

At step 302, a rotatable mounting element is provided, which can be attached to the adjustable clamping element via screw, ratchet, pin, rod or friction or other attachment means. The rotatable mounting element includes a plurality of mounting arms each spaced a specified distance apart from one another and extending at a specified angle from a bottom surface of the rotatable mounting element. Each pair of the plurality of mounting arms form a mounting slot therein between. The rotatable mounting element is capable of being rotated to position a first mounting slot in a vertical, horizontal or diagonal orientation and a second mounting slot in a vertical, horizontal or diagonal orientation to engage a first mounting surface in a vertical, horizontal or diagonal orientation or a second mounting surface in a vertical, horizontal or diagonal orientation.

For example, a rotatable mounting element can be formed in whole or part from stainless metal or other metal, alloy or plastic sheet stamped to form a clip or base plate with four arms extending from the base plate, spaced a specified distance apart and bent to a desired angle. If metal or other heat treatable material, the rotatable mounting element can be heat treated to form a rigid structure. The rotatable mounting element or a surface thereof can also be formed from rubber, polymeric material or other plastic, metal, alloy, or composite material that is rigid, semi-rigid or textured.

A zinc-alloy nut or other alloy or material can be formed using a die-cast mold to attach the rotatable mounting element to the adjustable clamping element. Glue is added to the cavity of the nut. The rotatable mounting element is affixed to the main body of the adjustable clamping element via the nut and a second stainless screw. A force gage is used to monitor the rotational force of the rotatable mounting element and the rotatable mounting element is adjusted if screw is too tight or loose.

TPE is injected into a mold to create a skirt and four socks. The skirt and four socks can also be formed from rubber, polymeric material or other plastic, metal, alloy, or composite material that is rigid, semi-rigid or textured. The skirt is assembled over the mounting arms of the rotatable mounting element. Glue is added to each mounting arm of the rotatable mounting element. A sock is inserted over each mounting arm, which holds the skirt in place.

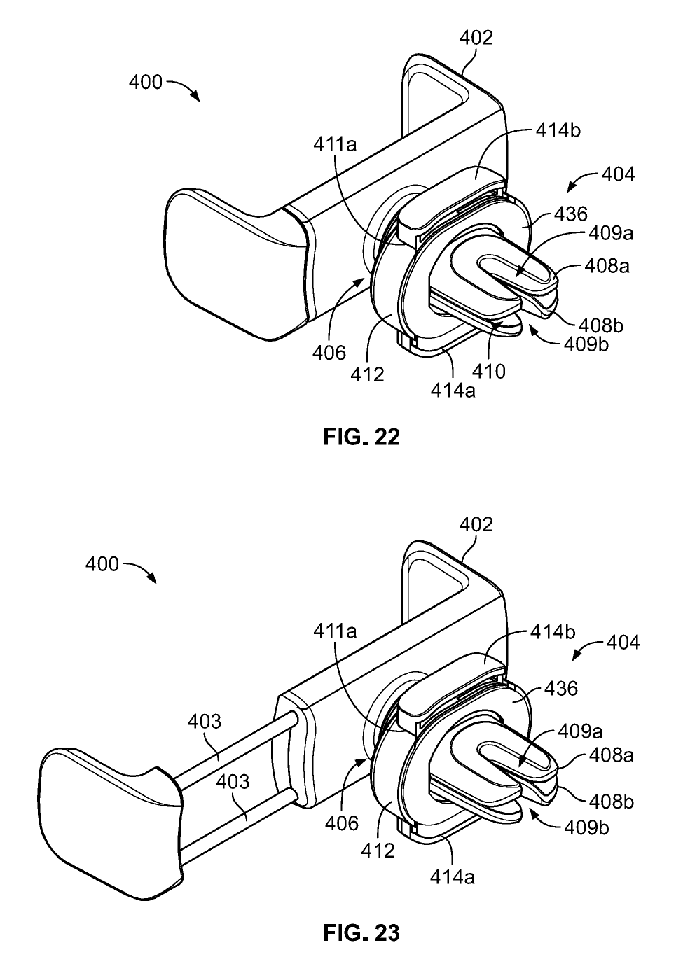

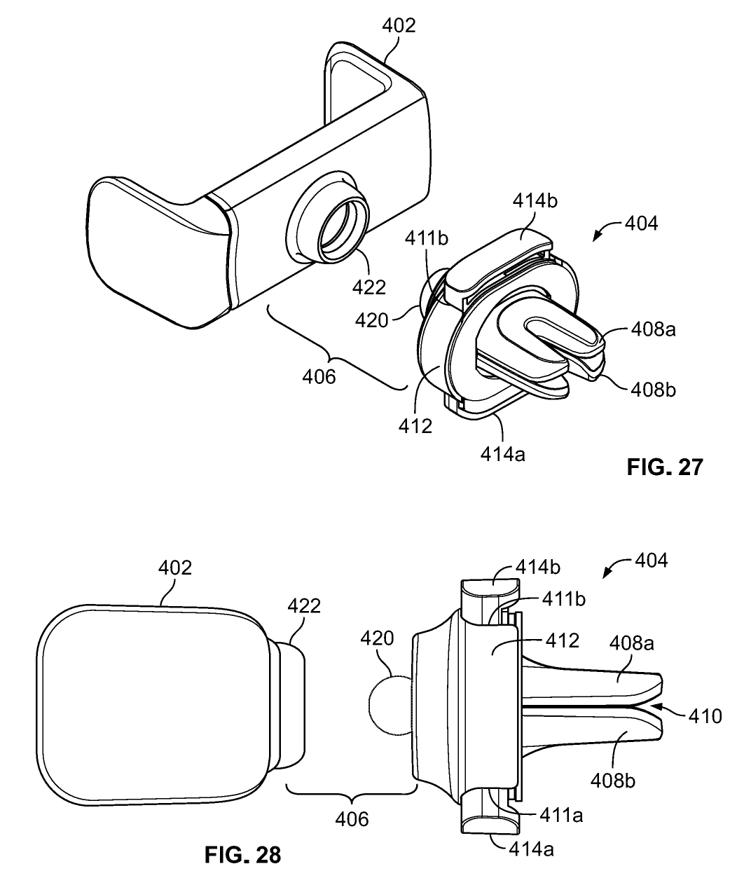

FIGS. 22-26 illustrate an adjustable portable device holder 400 according to a second embodiment of the present invention. The adjustable portable device holder 400 includes an adjustable clamping element 402 and a rotatable mounting element 404, which are connected to one another. More specifically, in the embodiment shown in FIGS. 22-26, the adjustable clamping element 402 and the rotatable mounting element 404 are connected to one another by a ball and socket joint 406. As shown in FIGS. 27 and 28, which show the clamping element 402 and the rotatable mounting element 404 separated from one another, the ball and socket joint 406 can include a ball 420 that extends from the rotatable mounting element 404 and a socket 422 that extends from and/or into a main body of the adjustable clamping element 402. In an alternative embodiment, the ball and socket joint 406 can include a ball 420 that extends from a main body of the clamping element 402 and a socket that extends from and/or into a housing or collar 412 of the rotatable mounting element 404. Where the rotatable mounting element 404 is also pivotable, it can also be referred to as a rotatable and pivotable mounting element 404. The rotatable mounting element 404 can also be referred to more succinctly as the mounting element 404, or alternatively, as mounting jaws 404. In accordance with an embodiment, the socket 422 includes a silicone liner that provides for a low static friction (also known as stiction) between the ball 420 and the socket 422, and thereby provides for smooth pivoting of the mounting element 404 and the adjustable clamping element 402 relative to one another. Instead of connecting the adjustable clamping element 402 and the rotatable mounting element 404 to one another using a ball and socket joint 406 such that they are both rotatable and pivotable relative to one another, they can be connected to one another such that they are just rotatable relative to one another (e.g., in a similar manner that the adjustable clamping element 102, 202 and the rotatable mounting element 104, 204 are connected to one another as discussed above with reference to FIGS. 1-21).

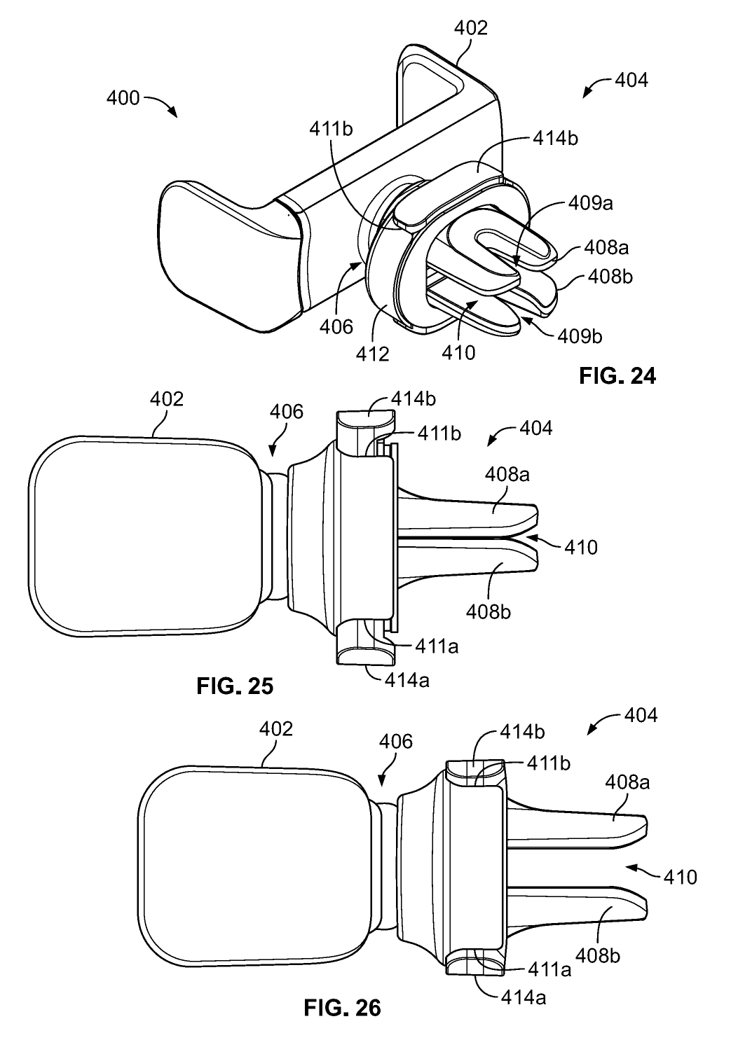

The adjustable clamping element 402 illustrated in FIGS. 22-26 can be expanded and retracted to attach devices (e.g., mobile phones or other mobile electronic devices) of different sizes to the adjustable portable device holder 400, as was the case with the adjustable portable device holder 100, 200 discussed above. In FIG. 22 the adjustable clamping element 402 is shown as being in a retracted setting, which can also be referred to as the deactivated state. By contrast, in FIG. 23 the adjustable clamping element 402 is shown as being in an expanded setting, which can also be referred to as the activated state. A force can be applied to expand or bias the adjustable clamping element 402 into an activated state (shown in FIG. 23) and the force can be released to retract the adjustable clamping element 102 into a deactivated state (shown in FIGS. 22 and 24). One or more elastic retracting or biasing element (not shown), such as a compression or torsion spring(s), can be incorporated into the adjustable clamping element 402. The compression or torsion spring(s) facilitates the expansion and retraction of the adjustable clamping element 402 upon applying or releasing an expansive force on a surface of the adjustable clamping element 402. As can be appreciated from FIG. 23, as was the case with the embodiment described above with reference to FIGS. 1-21, two stainless steel rods 403 connect a movable arm of the adjustable clamping element 402 to the main body of the adjustable clamping element 402. As was also the case with the embodiment described above with reference to FIGS. 1-21, a stainless steel spring (which cannot be seen in the FIGS.) can be inserted over each rod 403 and held in place by a stainless steel screw affixed to the end of the rods 403. Grease can be added to the lower portion of the spring and rods (near the screw head). As was the case with the embodiment described above with reference to FIGS. 1-21, when the adjustable clamping element 402 is completely retracted the rods 403 are not exposed and are thereby not viewable, as can be appreciated from FIG. 22. As was also the case with the embodiment described above with reference to FIGS. 1-21, when the adjustable clamping element 402 is at least partially expanded there is a gap, between the main body and the adjustable arm of the adjustable clamping element 402, with the rods 403 exposed and thereby viewable within the gap, as can be appreciated from FIG. 23.

The rotatable mounting element 404 includes mounting arms 408a and 408b, which can be referred to individually as a mounting arm 408, or collectively as the mounting arms 408. Each of the mounting arms 408a and 408b is shown as including a respective mounting slot or notch 409a and 409b, which can be referred to individually as a mounting slot or notch 409, or collectively as the mounting slots or notches 409. Additionally, a mounting slot 410 is defined between the opposing inner surfaces of the mounting arms 408a and 408b. The mounting arms 408a and 408b are biased such that they normally are pushed towards one another and come into contact with one another when nothing is interposed between them. An elastic biasing element (not shown in FIGS. 22-26), such as a compression or torsion spring, can be incorporated into the rotatable mounting element 404, e.g., as described below with reference to FIGS. 30B, 32B and 33. As will be described in more detail below, the mounting arms 408a and 408b can be separated from one another by pressing or squeezing the push buttons 414a and 414b such that the push buttons 414a and 414b move towards one another. While the push buttons 414a and 414b are pressed, which causes the mounting arms 408a and 408b to be separated from one another, the portable device holder 400 (and more specifically, the mounting element 404 thereof) can be mounted to an air conditioner vent blade by inserting the mounting slot 410 over the vent blade. After the mounting slot 410 is inserted over the vent blade, the push buttons 414a and 414b can be released and the biasing element (e.g., the spring 417 shown in FIGS. 30B, 32B and 33) will bias the mounting arms 408a and 408b such that they normally are pushed towards one another and come into contact with opposing surfaces of the vent blade, thereby gripping the vent blade and securely mounting the portable device holder 400 to the vent blade. It is also possible to mount the mounting element 404 to an alternative mounting surface besides a vent blade.

As shown for example in FIGS. 4A and 4B discussed above, an automobile may include both vertical and horizontal air conditioner vent blades that are perpendicular to one another. The mounting slots or notches 409a and 409b in the mounting arms 408a and 408b enable a vertical (or horizontal) vent blade to be grasped within the mounting slot 410 between the mounting arms 408a and 408b while a perpendicular horizontal (or vertical) vent blade rests within the mounting slots or notches 409a and 409b.

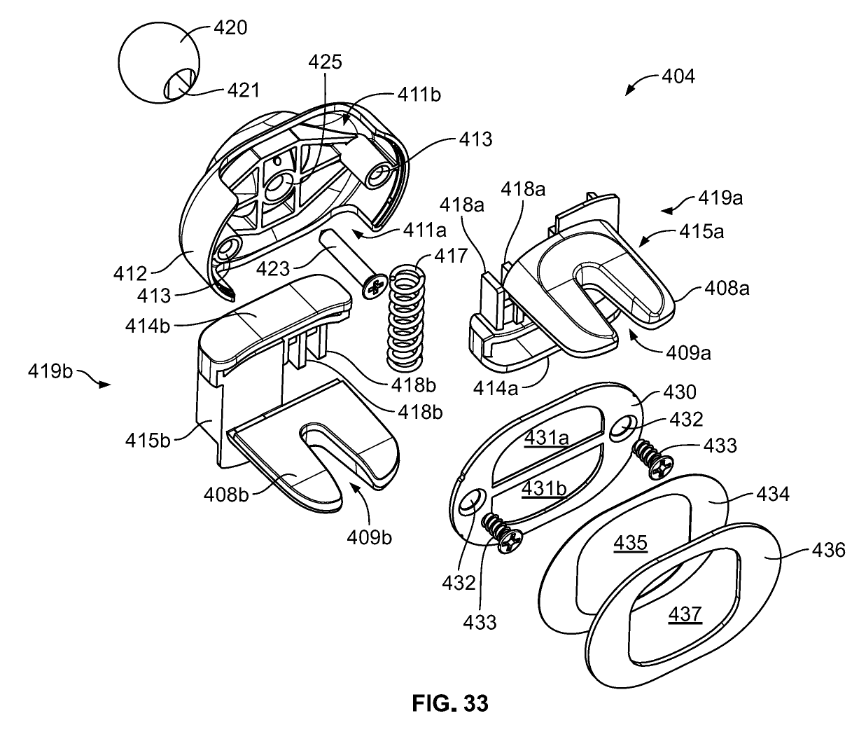

The rotatable mounting element 404 includes a housing or collar 412 that supports push buttons 414a and 414b, which can be referred to individually as a push button 414, or collectively as the push buttons 414. As will be described in additional detail below, initially with reference to FIGS. 24-26, pushing or pressing on the push buttons 414a and 414b causes the mounting arms 408a and 408b to move away from one another to thereby increase the size of the slot 410 defined between the opposing inner surfaces of the mounting arms 408a and 408b. A recess 411b in an upper peripheral portion of the housing or collar 412 enables the upper push button 414b to extend beyond the housing or collar 412. Similarly, a recess 411a in a lower peripheral portion of the housing or collar 412 enables the lower push button 414b to extend beyond the housing or collar 412. Such recesses 411a and 411b can be seen best in FIG. 33 discussed below.

FIG. 25 is a right elevation view of the adjustable portable device holder 400 with its mounting element 404, which can also be referred to as vent attachment jaws 404, in a closed position, which can also referred to as the deactivated position. FIG. 25 is a right elevation view of the adjustable portable device holder 400 with its mounting element 404, which can also be referred to as vent attachment jaws 404, in an open position, which can also referred to as the activated position. In accordance with an embodiment, the vent attachment jaws 404 can be transitioned from the closed or deactivated position shown in FIG. 25 to the open or activation position shown in FIG. 26 in response to a person pressing on the push buttons 414 with at least a pair of their fingers, and more specifically, squeezing the push buttons 414 such that they move towards one another.

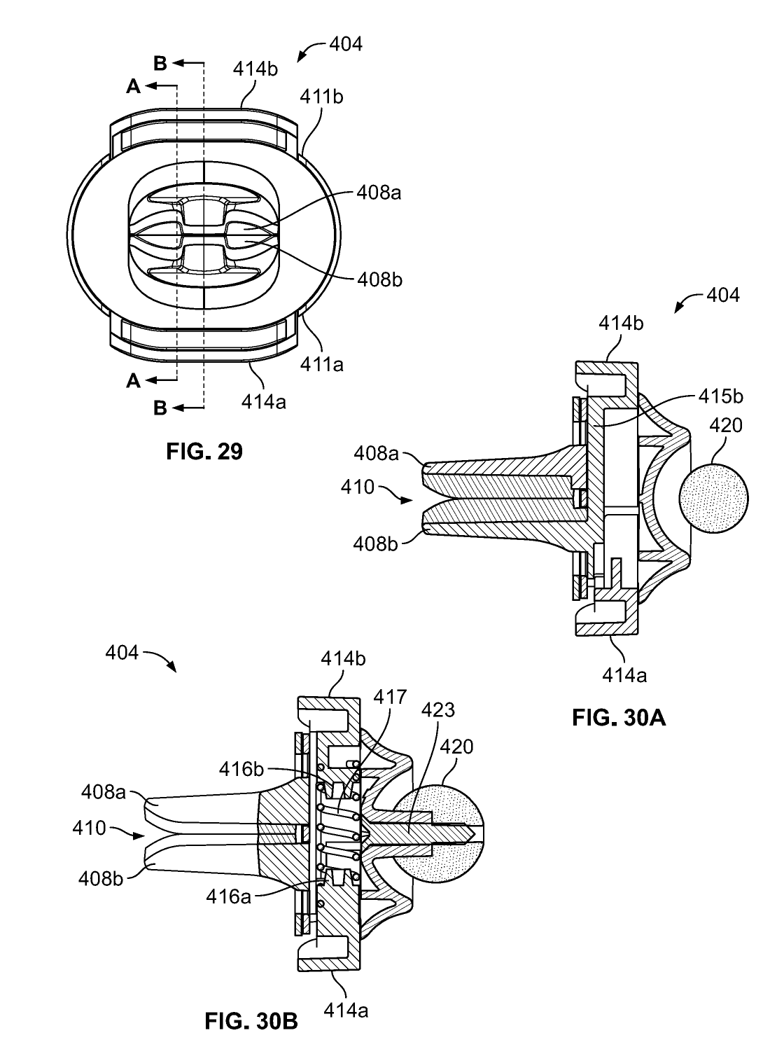

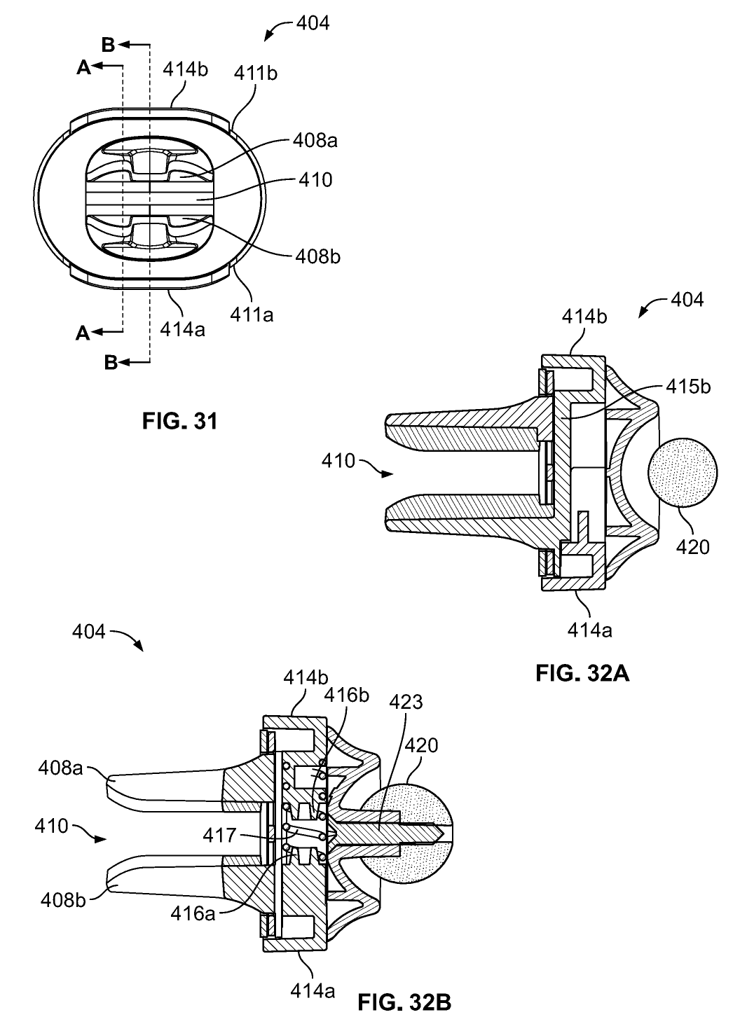

FIG. 29 is a rear elevation view of the mounting element 404 (which can also be referred to as the vent attachment jaws 404) in a closed position (which can also be referred to as the deactivated position). FIGS. 30A and 30B are cross-sectional side views of the mounting element 404 along the lines A-A and B-B, respectively, shown in FIG. 29, with the mounting element in a closed position (also referred to as the deactivated position). FIG. 31 is a rear elevation view of the mounting element 404 (which can also be referred to as the vent attachment jaws 404) in an open position (which can also be referred to as the activated position). FIGS. 32A and 32B are cross-sectional side views of the mounting element 404 along the lines A-A and B-B, respectively, shown in FIG. 31, with the mounting element in an open position (also referred to as the activated position). FIG. 33 is an exploded rear perspective view of the mounting element 404 of the adjustable portable device holder 400.

As can appreciated from FIGS. 30A, 32A and 33, the upper push button 414b is attached to the lower mounting arm 408b (which can also be referred to as the lower jaw 408b) by a post 415b. More specifically, in accordance with an embodiment, the upper push button 414b, the post 415b, and the lower mounting arm 408b (which can also be referred to as the lower jaw 408b) are integrally formed (e.g., integrally molded), and thus, can collectively be referred to as an integrally formed button and arm structure 419b. A spring peg 416b (for holding an upper end of the spring 417 in place) can also be part of the integrally formed button and arm structure 419b, as shown in FIGS. 30B and 32B. Similarly, the lower push button 414a, the post 415a, and the upper mounting arm 408a (which can also be referred to as the upper jaw 408a) are integrally formed (e.g., integrally molded), and thus, can collectively be referred to as an integrally formed button and arm structure 419a. A spring peg 416a (for holding a lower end of the spring 417 in place) can also be part of the integrally formed button and arm structure 419a, as shown in FIGS. 30B and 32B.

As shown in FIG. 33, the integrally formed button and arm structure 419a includes ribs 418a, and the integrally formed button and arm structure 419b similarly includes ribs 418b. In accordance with an embodiment, the ribs 418a and 418b intermesh with one another to help keep the integrally formed button and arm structures 419a and 419b in proper alignment with one another as the slot 410 between the upper and lower mounting arms 408a and 408b is expanded and retracted in response to the push buttons 414a and 414b being selectively pressed and released.

Each integrally formed button and arm structure 419a and 419b can be molded. Where there is a desire to make each integrally formed button and arm structure 419a and 419b from more than one material, then a multi-material injection molding process (e.g., multi-component, multi-shot, or over-molding) can be used to manufacture each structure. For example, a majority of each structure can be made of a relatively hard plastic or other polymer, and opposing inner surfaces of the mounting arms 408a and 408b (that are intended to grip a mounting surface, e.g., an air conditioner vent blade) and/or portions of the push buttons 414a and 414b (that are intended to be pushed by a person's fingers) can be made of a softer gripping material. Such a gripping material can be any material that increases the adhesion, grip or coefficient of friction between a gripping surface of the mounting arms or jaws 408a and 408b and a mounting surface, or between the push buttons 414a and 414b and a persons' fingers. The gripping material can include, but is not limited to rubber, polymeric material or other plastic, fabric, composite material or other material capable of increasing the adhesion, grip or coefficient of friction. A gripping material and a gripping surface can be textured and composed of the same or different material.

Still referring to FIG. 33, the housing or collar 412 is shown as including two internal screw holes 413 near its opposing sides, and a center through hole 425. During assembly, a screw or other fastener 423 is inserted through the center through hole 425 and into an opening 421 in the ball 420 to thereby secure the ball 420 to the housing or collar 412. In an embodiment, the ball 420 is already placed within the socket 422 before the screw or other fastener 423 is inserted into the opening 421 in the ball 420 to thereby secure the ball 420 to the housing or collar 412. Thereafter, the integrally formed button and arm structures 419a and 419b are aligned with one another such that the ribs 418a and 418b intermesh with one another and the spring 417 is held between the spring pegs 416a and 416b (e.g., shown in FIG. 30B). Portions of the aligned integrally formed button and arm structures 419a and 419b are then placed within the housing or collar 412 such that the upper push button 414b is within the recess 411b and extends beyond an upper portion of the housing or collar 412 and the lower push button 414a is within the recess 411a and extends beyond a lower portion of the housing or collar 412. An inner plate 430 is then placed over a back of the housing or collar 412 such that the upper mounting arm 408a extends through an upper opening 431a in the inner plate 430, the lower mounting arm 408b extends through a lower opening 431b in the inner plate 430, and the through holes 432 are aligned with the screw holes 413. Alternatively, the inner plate 430 can be assembled onto the aligned integrally formed button and arm structures 419a and 419b (such that the upper mounting arm 408a extends through an upper opening 431a in the inner plate 430, the lower mounting arm 408b extends through a lower opening 431b in the inner plate 430, and the through holes 432 are aligned with the screw holes 413) prior to the integrally formed button and arm structures 419a and 419b being placed within the housing or collar 412. A pair of screws 433 are then inserted though the through holes 432 of the inner plate 430 and screwed into the screw holes 413 of the housing or collar 412 to hold the integrally formed button and arm structures 419a and 419b and the spring 417 in their appropriate alignment within the housing or collar 412. A double-sided adhesive tape 434 including an opening 435 (or an alternative adhesive, such as an epoxy or glue) is used to adhere an outer plate 436 including an opening 437 to the inner plate 430, and thereby cover up the heads of the screws 433 so that they are not visible. The inner plate 430 can be made of a metal or plastic, but is not limited thereto. The outer plate 436 can be made of a metal, plastic or silicone, but is not limited thereto.

In the embodiments described above, the adjustable clamping elements 102, 202, 402 were described as being used to removably secure one of a plurality of different sized portable devices (e.g., mobile phones) to the adjustable clamping elements, and thereby, to a respective one of the portable device holders 100, 200, 400. In such embodiments, the adjustable clamping elements 102, 202, 402 are examples of device attachment elements, which together with the respective mounting elements 104, 204, 404 are used to mount portable devices (e.g., mobile phones) of various different sizes to an air conditioner vent blade or other mounting surface. In accordance with alternative embodiments, other types of device attachment elements can be used in place of the adjustable clamping elements 102, 202, 402. For example, in certain embodiments, a device attachment element can include one or more magnets (e.g., rare earth magnet(s)) that enable selective attachment of portable devices of various different sizes to the device attachment element. In order for a portable device to be attached to the device attachment element including one or more magnets, a metal plate should be secured directly to the back of the portable device by an adhesive or placed between a protective case (e.g., a mobile phone case) and the portable device (e.g., a mobile phone). It would also be possible for the metal plate to be build into a protective case (e.g., a mobile phone case) for a portable device. If a portable device already includes a surface made of a ferromagnetic metal, then there may be no need for the aforementioned metal plate.

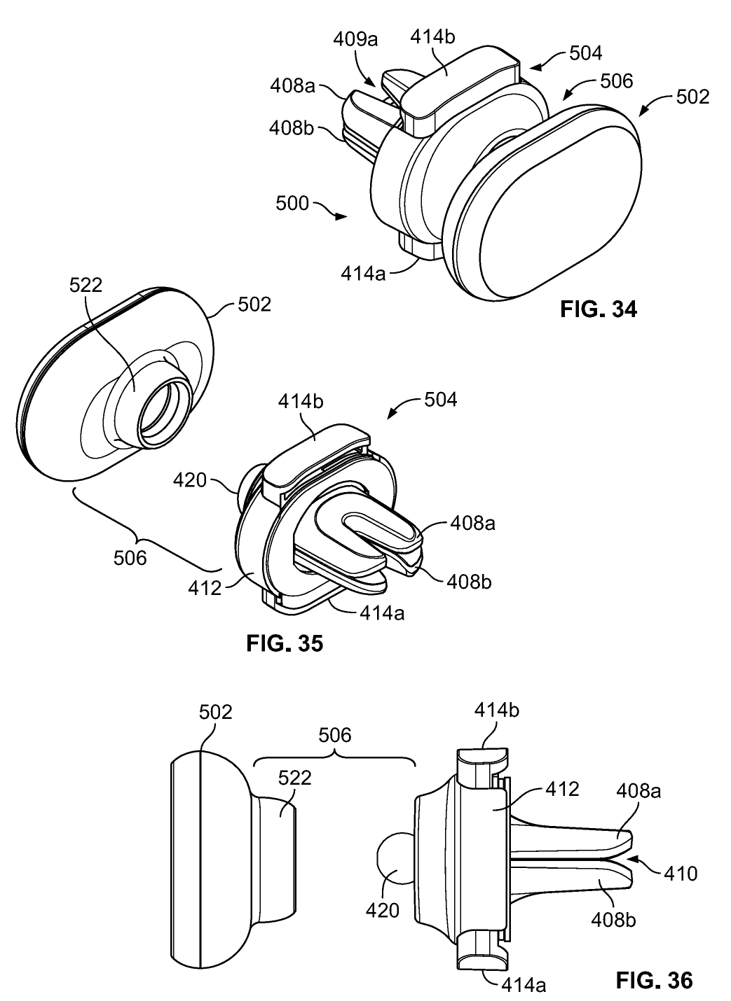

FIG. 34 is a front perspective view of an adjustable portable device holder 500 according to a third embodiment of the present invention. The portable device holder 500 is shown as including a device attachment element 502 and a rotatable mounting element 504 which are connected to one another by a ball and socket joint 506. FIGS. 35 and 36 are respectively rear perspective and right elevation views of the adjustable portable device holder 500 according to the third embodiment of the present invention with the device attachment element 502 and the mounting element 504 shown separate from one another.

The rotatable mounting element 504 is the same as the rotatable mounting element 404 described above with reference to FIGS. 22-33, and thus, components of the rotatable mounting element 504 are labeled the same as the components of the rotatable mounting element 404, and need not be described again. The ball and socket joint 506 is substantially the same as the ball and socket joint 406 described above, e.g., with reference to FIGS. 27 and 28. As shown in FIGS. 35 and 36, which show the clamping element 402 and the rotatable mounting element 404 separated from one another, the ball and socket joint 506 can include a ball 420 that extends from the rotatable mounting element 504 and a socket 522 that extends from and/or into a main body of the device attachment element 502. In an alternative embodiment, the ball and socket joint 506 can include a ball that extends from a main body of the device attachment element 502 and a socket that extends from and/or into a housing or collar 412 of the rotatable mounting element 504. Where the rotatable mounting element 504 is also pivotable, it can also be referred to as a rotatable and pivotable mounting element 504. The rotatable mounting element 504 can also be referred to more succinctly as the mounting element 504, or alternatively, as mounting jaws 504. In accordance with an embodiment, the socket 522 includes a silicone liner that provides for a low static friction (also known as stiction) between the ball 420 and the socket 522, and thereby provides for smooth pivoting of the mounting element 504 and the device attachment element 502 relative to one another. Instead of connecting the device attachment element 502 and the rotatable mounting element 504 to one another using a ball and socket joint 506 such that they are both rotatable and pivotable relative to one another, they can be connected to one another such that they are just rotatable relative to one another (e.g., in a similar manner that the adjustable clamping element 102, 202 and the rotatable mounting element 104, 204 are connected to one another as discussed above with reference to FIGS. 1-21).

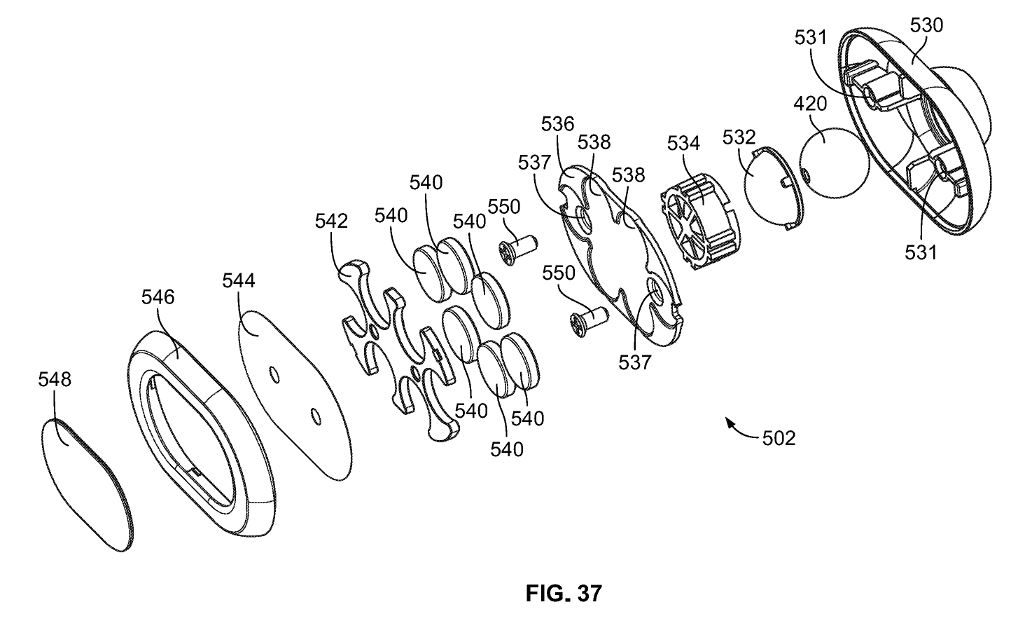

FIG. 37 is an exploded front perspective view of the device attachment element 502 of the adjustable portable device holder 500. The device attachment element 502 is shown as including a housing 530 having screw holes 531, a socket liner 532, a socket brace or spacer 534, and a backer plate 536 including a pair of through holes 537 and six recesses or pockets 538 for holding magnets 540. The device attachment element 502 is also shown as including a magnet tray 542, an adhesive tape 544, a bezel 546, and a front plate 548. In accordance with an embodiment, the housing 530 is molded from PC (polycarbonate) or some other plastic, but is not limited thereto. The socket liner 532 can be made of silicone, but is not limited thereto. The socket brace or spacer 534 can be molded from PC, PC/ABS (polycarbonate/acrylonitrile-butadiene-styrene terpolymer blend), or some other plastic, but is not limited thereto. The backer plate 536 can be made of a plastic or a metal, such as stainless steel, but is not limited thereto. In accordance with certain embodiments, the backer plate 536 is made of a ferromagnetic metal, which helps keep the magnets 540 in place. Preferably, the backer plate 536 is relatively stiff so as to help put pressure on the socket 506. During manufacture, a pair of screws 550 are inserted through the through holes 537 in the backer plate 536 and screwed into the screw holes 531 in the housing 530 with the socket brace or spacer 534, the socket liner 532 and the ball 420 therebetween to thereby hold the socket liner 532 and the ball 420 in their proper positions. The magnets 540 are positioned in the recesses or pockets 538 and maintained in their spaced apart relationship by the magnet tray 542. The magnets 540 can include Neodimium or some other rare-earth magnetic material that can be used to form a permanent magnet. The adhesive tape 544 (or an alternative adhesive, such as an epoxy or glue) is used to adhere the front plate 548 to the bezel 546, and to adhere the magnet tray 542 and the magnets 540 to the bezel 546 and the front plate 548. The bezel 546 can snap onto the backer plate 536 and/or be connected to the backer plate 536 using an adhesive, after the backer plate 536 has been screwed onto the housing 530, to thereby connect the bezel 546 to the housing 530.

Example embodiments have been described hereinabove regarding adjustable portable device holder systems and methods. Various modifications to and departures from the disclosed example embodiments will occur to those having ordinary skill in the art. The subject matter that is intended to be within the spirit of this disclosure is set forth in the following claims.

What is claimed is:

1. A portable device holder comprising:
an adjustable clamping element comprising first and second opposing side grips and a main body;
a mounting element attached to the adjustable clamping element and comprising first and second mounting arms extending in a direction away from the main body of the adjustable clamping element to define a mounting slot therebetween that is configured to accommodate engagement with a mounting surface;
the adjustable clamping element being adjustable by linearly translating, relative to the main body, a portion of the adjustable clamping element from which the first side grip extends to thereby secure a portable device to the adjustable clamping element;
the mounting element rotatable relative to the adjustable clamping element and thereby enabling the mounting slot to be selectively rotated between vertical and horizontal arrangements relative to the adjustable clamping element;
wherein when the adjustable clamping element is completely retracted the portion of the adjustable clamping element from which the first side grip extends is flush with a side portion of the main body of the adjustable clamping element; and
wherein when the adjustable clamping element is at least partially expanded, by application of an expansive force to cause the portion of the adjustable clamping element from which the first side grip extends to be linearly translated relative to the main body of the adjustable clamping element, there is a gap between the side portion of the main body of the adjustable clamping element and the portion of the adjustable clamping element from which the first side grip extends.

2. The portable device holder of claim 1, wherein:
the adjustable clamping element further comprises a rod over which a spring, that facilitates at least one expansion or retraction of the adjustable clamping element, is inserted; and
the portion of the adjustable clamping element from which the first side grip extends is translatable relative to the main body of the adjustable clamping element.

3. The portable device holder of claim 2, further comprising a fastener that secures the spring to the rod.

4. The portable device holder of claim 3, wherein the fastener comprises a screw that is affixed to an end of the rod and holds the spring in place.

5. The portable device holder of claim 1, wherein the mounting arms also comprise a gripping surface constructed from rubber, polymeric material or plastic.

6. The portable device holder of claim 1, further comprising:
a ball and socket joint that connects the mounting element to the adjustable clamping element;
wherein the ball and socket joint is configured to enable to the mounting element and the adjustable clamping element to be both rotatable and pivotable relative to one another.

7. The portable device holder of claim 1, wherein:
the portion of the adjustable clamping element from which the first side grip extends comprises an L-shaped portion of the adjustable clamping element;
when the adjustable clamping element is completely retracted the L-shaped portion of the adjustable clamping element is flush with the side portion of the main body of the adjustable clamping element; and
when the adjustable clamping element is at least partially expanded, by application of an expansive force to cause the L-shaped portion of the adjustable clamping element to be linearly translated relative to the main body of the adjustable clamping element, there is a gap between the side portion of the main body of the adjustable clamping element and the L-shaped portion of the adjustable clamping element.

8. The portable device holder of claim 7, further comprising at least one rod that connects the main body of the adjustable clamping element to the L-shaped portion of the adjustable clamping element.

9. The portable device holder of claim 1, wherein the mounting element comprises:
first and second integrally formed button and arm structures; and
a spring including first and second ends;
the first integrally formed button and arm structure including an upper push button connected to a lower one of the mounting arms by a first post and also including a first spring peg;
the second integrally formed button and arm structure including a lower push button connected to an upper one of the mounting arms by a second post and also including a second spring peg;
the first end of the spring connected to the first spring peg; and
the second end of the spring connected to the second spring peg;
wherein when the upper and lower push buttons are pushed towards one another, the lower and upper mounting arms move away from one another to thereby increase a size of the mounting slot therebetween.

10. The portable device holder of claim 9, wherein:
the first integrally formed button and arm structure also includes first ribs;
the second integrally formed button and arm structure also includes second ribs; and
the first ribs of the first integrally formed button and arm structure and the second ribs of the second integrally formed button and arm structure intermesh with one another to align the first and second integrally formed button and arm structures relative to one another and maintain their alignment when the upper and lower push buttons are pushed towards one another, which causes the lower and upper mounting arms to move away from one another and thereby increase a size of the mounting slot therebetween;
the mounting surface, to which the mounting slot of the mounting element accommodates engagement with, comprises an air conditioner vent blade of an automobile.

11. A portable device holder comprising:
a device attachment element including a main body and configured to be selectively attached to a portable device;
a mounting element attached to the device attachment element and configured to attach the portable device holder to a mounting surface;
the mounting element comprising first and second integrally formed button and arm structures and also comprising a spring including first and second ends;
the first integrally formed button and arm structure including an upper push button connected to a lower mounting arm by a first post and also including first ribs and a first spring peg;
the second integrally formed button and arm structure including a lower push button connected to an upper mounting arm by a second post and also including second ribs and a second spring peg;
the first end of the spring connected to the first spring peg;
the second end of the spring connected to the second spring peg;
a mounting slot defined between the lower and upper mounting arms of the first and second integrally formed button and arm structures;
the first ribs of the first integrally formed button and arm structure and the second ribs of the second integrally formed button and arm structure intermeshed with one another to align the first and second integrally formed button and arm structures relative to one another and maintain their alignment when the upper and lower push buttons are pushed towards one another, which causes the lower and upper mounting arms to move away from one another and thereby increase a size of the mounting slot therebetween; and
the mounting element rotatable relative to the device attachment element and thereby enabling the mounting slot to be selectively rotated between vertical and horizontal arrangements relative to the device attachment element.

12. The portable device holder of claim 11, wherein:
the device attachment element comprises an adjustable clamping element comprising first and second opposing side grips and the main body; and
the adjustable clamping element is adjustable by linearly translating, relative to the main body, a portion of the adjustable clamping element from which the first side grip extends to thereby secure a portable device to the adjustable clamping element and thereby to the portable device holder.

13. The portable device holder of claim 11, wherein:
the device attachment element includes one or more magnets within the main body that enable a portable device having a metal plate attached thereto to be magnetically attached to the device attachment element and thereby to the portable device holder.

14. The portable device holder of claim 11, further comprising:
a ball and socket joint that connects the mounting element to the device attachment element;
wherein the ball and socket joint is configured to enable to the mounting element and the device attachment element to be both rotatable and pivotable relative to one another.

15. The portable device holder of claim 11, wherein each of the upper and lower mounting arms include a respective notch that is perpendicular to the mounting slot defined between the lower and upper mounting arms of the first and second integrally formed button and arm structures.

16. A portable device holder comprising:
a device attachment element that is configured to be selectively attached to a portable device;
a mounting element rotatably attached to a main body of the device attachment element;
the mounting element comprising first and second mounting arms extending in a direction away from the main body of the device attachment element and defining a mounting slot behind the main body of the device attachment element;
the mounting slot configured to accommodate engagement with an air conditioner vent of an automobile;
the mounting slot rotatable relative to the device attachment element by rotating the mounting element relative to the main body of the device attachment element thereby enabling the mounting slot behind the main body of the device attachment element to be selectively rotated between vertical and horizontal arrangements relative to the device attachment element;
wherein the portable device holder has a front and a back; and
wherein when the portable device holder is viewed from the front, the mounting arms of the mounting element and the mounting slot defined by the mounting arms are hidden behind the main body of the device attachment element and are thus not viewable.

17. The portable device holder of claim 16, wherein:
the device attachment element comprises an adjustable clamping element including first and second side grips and the main body;
when the adjustable clamping element is completely retracted a portion of the adjustable clamping element from which first side grip extends is flush with a side portion of the main body of the adjustable clamping element; and
when the adjustable clamping element is at least partially expanded, by application of an expansive force to cause the portion of the adjustable clamping element from which the first side grip extends to be linearly translated relative to the main body of the adjustable clamping element, there is a gap between the side portion of the main body of the adjustable clamping element and the portion of the adjustable clamping element from which the first side grip extends.

18. The portable device holder of claim 17, wherein:
the adjustable clamping element has a length and a height that is perpendicular to the length;
the length of the adjustable clamping element increases when the adjustable clamping element is expanded; and
the mounting element is rotatably and pivotably attached to the adjustable clamping element such that rotatable mounting element is centered relative to the height of the adjustable clamping element.

19. The portable device holder of claim 16, wherein the mounting element comprises:
first and second integrally formed button and arm structures;
the first integrally formed button and arm structure including an upper push button connected to a lower one of the mounting arms by a first post;
the second integrally formed button and arm structure including a lower push button connected to an upper one of the mounting arms by a second post; and
wherein in response to the upper and lower push buttons being pushed towards one another the lower and upper mounting arms move away from one another and thereby increase a size of the mounting slot therebetween.

20. The portable device holder of claim 19, wherein the mounting element further comprises a spring that provides a bias force that biases the first and second mounting arms towards one another and which bias force is temporarily overcome while the upper and lower buttons are pushed towards one another.
